(19) United States
(12) Patent Application Publication
(10) Pub. No.: US 2013/0170342 A1
(43) Pub. Date: Jul. 4, 2013

(54) DATA COMMUNICATION SYSTEMS AND METHODS

(71) Applicant: Mohammed Abdullah Alnuem, Riyadh (SA)

(72) Inventor: Mohammed Abdullah Alnuem, Riyadh (SA)

(73) Assignee: King Saud University, Riyadh (SA)

(21) Appl. No.: 13/017,020

(22) Filed: Feb. 3, 2011

(51) Int. Cl. H04L 12/56

(52) U.S. Cl. CPC H04L 47/25
USPC 370/230

(57) ABSTRACT

Data communication systems and methods are described. In one aspect, data is communicated to a data receiver via a data communication network. An error discriminator receives a confirmation response from the data receiver indicating receipt of the data. A round-trip transmission time is determined for the data and used to predict network congestion associated with the data communication network. A data communication rate is adjusted if the predicted network congestion exceeds a threshold value.

### BACKGROUND

Data communication networks may experience congestion, dropped data packets and other communication problems that affect the performance of the network. When a network experiences congestion, it is desirable to reduce the data flowing across the network, at least for a short period of time, to resolve the congestion. Certain data communication protocols, such as TCP (Transmission Control Protocol), define procedures that require data senders to reduce data transmission rates in response to network congestion. Otherwise, the network congestion may increase and further degrade the network's performance.

Some network-enabled devices include an error discriminator that attempts to differentiate between different types of data communication errors. The error discriminator typically operates differently depending on the type of error. For example, if the error is related to network congestion, then the error discriminator reduces the data communication rate until the network congestion is reduced. If the error is not related to network congestion, the error discriminator takes different actions to resolve the error. Many existing error discriminators have preset operating parameters that are selected to provide a good general performance, but may suffer diminished performance when network conditions are changing rapidly.

### SUMMARY

A data communication system communicates data to a data receiver via a data communication network. An error discriminator receives a confirmation response from the data receiver indicating receipt of the data. A round-trip transmission time is calculated for the data and used to predict network congestion associated with the data communication network. A data communication rated is adjusted if the predicted network congestion exceeds a threshold value.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 illustrates an example environment capable of implementing the systems and methods described herein.

FIG. 2 is a block diagram illustrating various components of a data server, according to one embodiment.

FIG. 3 shows an example procedure for communicating data from a data server to a data receiver, according to one embodiment.

FIG. 4 shows an example procedure for responding to dropped data packets, according to one embodiment.

FIG. 5 shows an example data transmission having multiple DACK (duplicate acknowledgment) signals, according to one embodiment.

FIG. 6 shows an example procedure for classifying a dropped packet as a congestion-related drop or a transmission drop, according to one embodiment.

FIG. 7 shows an example procedure for calculating a congestion edge, according to one embodiment.

FIG. 8 is a block diagram illustrating an example computing device, according to one embodiment.

### DETAILED DESCRIPTION

### Overview

The systems and methods described herein relate to the communication of data between a data server and a data receiver. These data communication systems and methods monitor various data congestion and data transmission parameters to improve network utilization and reduce dropped data packets. The data server monitors data transmission times to predict network congestion. Based on the predicted network congestion, the data server adjusts the data transmission rate, as necessary, to improve network throughput and avoid increasing the network congestion. Additionally, the data communication systems and methods described herein can reduce the number of dropped data packets, which results in fewer retransmissions of data packets.

The data communication systems and methods are capable of use with existing data receivers and existing data communication networks. Thus, a data server implementing the methods discussed herein can operate with existing data receiver equipment without requiring any modification of the existing equipment. The data server can also operate with existing data communication networks, regardless of network topology or communication protocols.

### An Exemplary System for Communicating Data

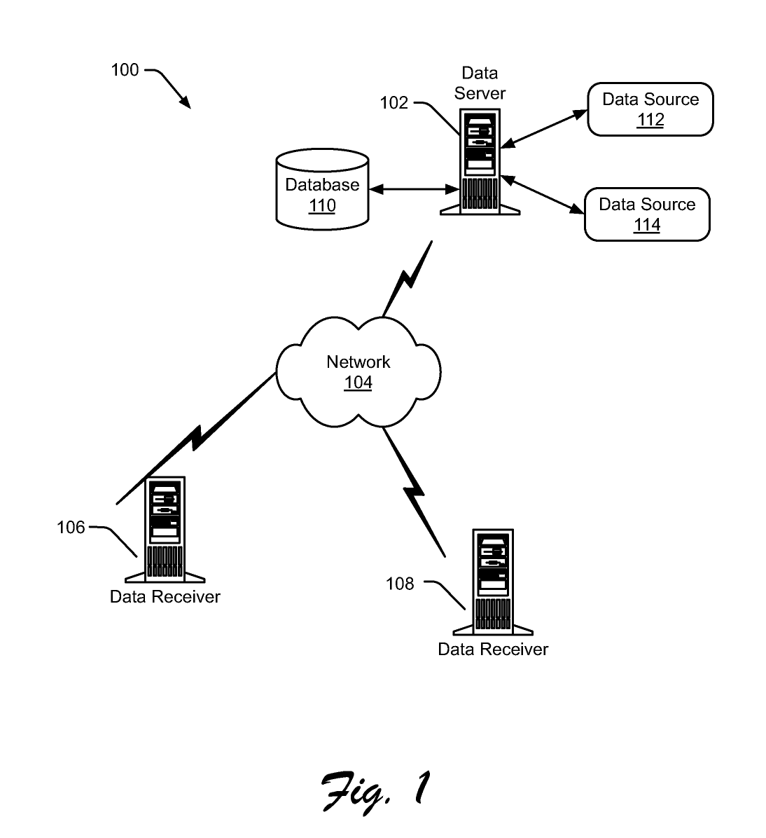

FIG. 1 illustrates an example environment 100 capable of implementing the systems and methods described herein. Environment 100 includes a data server 102 and two data receivers 106 and 108 that communicate with one another via a data communication network 104. Data server 102 represents any type of computing device, such as a server or a workstation. Data receivers 106 and 108 also represent any type of computing device, such as a server, workstation, laptop computer, tablet computer, handheld computing device, smart phone, personal digital assistant, game console, set top box, and the like.

Data server 102 is coupled to receive data from a database 110 as well as data sources 112 and 114. Data sources 112 and 114 can provide any type of data to data server 102. Similarly, database 110 may store any type of data in a format that is accessible by data server 102. In particular embodiments, data sources 112 and 114 are located remotely from data server 102 and coupled to the data server via a data communication network or other communication link.

As discussed herein, data server 102 receives data from database 110 and/or data sources 112 and 114 for communication to a data receiver (e.g., data receiver 106 or 108) via data communication network 104. Data server 102 may perform additional functions, such as analyzing data flow across data communication network 104, adjusting data communication rates based on network congestion, and so forth.

Data communication network 104 represents any type of network, such as a local area network (LAN), wide area network (WAN), or the Internet. In particular embodiments, data communication network 104 is a combination of multiple networks communicating data using various protocols across any communication medium. For example, data communication network 104 may be a heterogeneous network coupled to devices using different operating systems or different data communication protocols. In another example, data communication network 104 is a combination of both wired and wireless data networks, including one or more mobile networks.

Although one data server 102 and two data receivers 106, 108 are shown in FIG. 1, alternate embodiments may include any number of data servers and any number of data receivers coupled together via any number of data communication networks 104 or other communication links. In other embodiments, data server 102 is replaced with any other type of computing device or replaced with a group of computing devices.

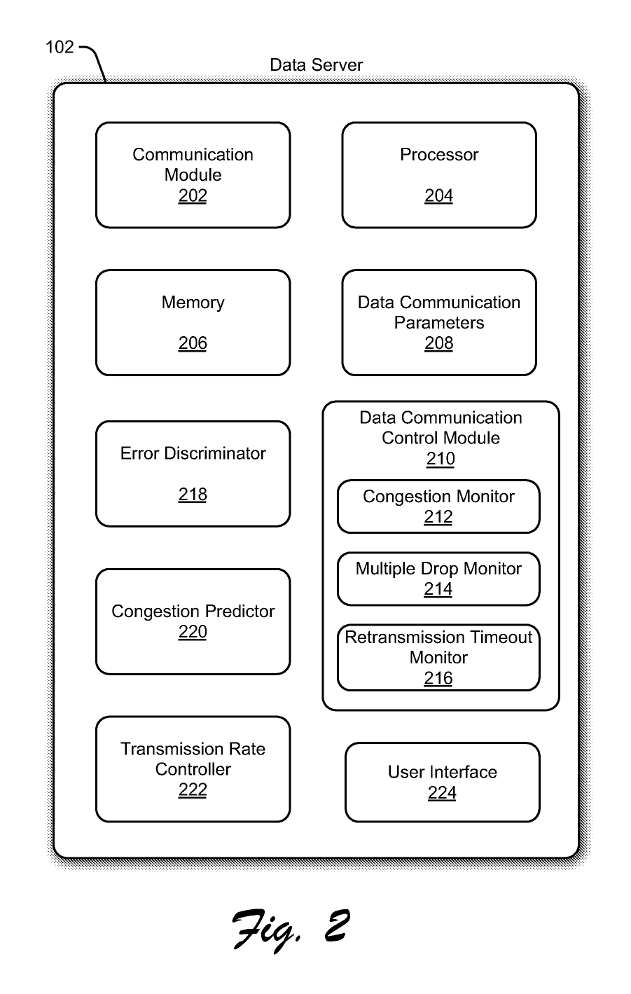

FIG. 2 is a block diagram illustrating various components of data server 102, according to one embodiment. As mentioned above, data server 102 performs various functions, such as analyzing the flow of data across a network and adjusting data communication rates and other data communication parameters based on network congestion. These data management functions improve the data communication performance between data server 102 and one or more data receivers.

Data server 102 includes a communication module 202, a processor 204, and a memory 206. Communication module 202 allows data server 102 to communicate with other devices and systems, such as databases, data sources and data receivers. Communication module 202 may communicate data via a wired or wireless communication link using any data communication protocol. Specific examples discussed herein utilize TCP (Transmission Control Protocol). Processor 204 executes various instructions to implement the functionality provided by data server 102. Memory 206 stores these instructions as well as other data used by processor 204 and other modules contained in data server 102. Data server 102 also includes data communication parameters 208 that define the manner in which data management functions are performed by the data server.

A data communication control module 210 in data server 102 includes a congestion monitor 212, a multiple drop monitor 214, and a retransmission timeout monitor 216. Data communication control module 210 manages the communication of data from data server 102 to one or more data receivers. Data communication control module 210 adjusts data transmission rates and other data communication parameters based on information about the communication network, such as congestion, dropped data packets, and so forth.

Congestion monitor 212 identifies current data congestion levels in one or more data communication networks. Multiple drop monitor 214 identifies the number of dropped data packets as well as the number of data packets that dropped from the same congestion window. Retransmission timeout monitor 216 identifies the number of data packets that are not successfully retransmitted across a data communication network due to a timeout.

Data server 102 also includes an error discriminator 218 that identifies errors that occur during the transmission of data across a data communication network. Error discriminator 218 is capable of distinguishing between different types of errors, such as errors resulting from network congestion and errors caused by non-congestion factors. Based on the types of errors occurring at a particular time, data server 102 can make appropriate adjustments to the data transmission rate and other parameters to improve network utilization and data throughput. Additionally, the error information identified by error discriminator 218 is useful to data server 102 in determining whether to adjust the size of a congestion window, as discussed herein.

A congestion predictor 220 in data server 102 predicts congestion in the data communication network based on measured transmission times between data server 102 and one or more data receivers. In a particular embodiment, congestion predictor 220 applies data traffic correlation information, commonly referred to as Long Range Dependence (LRD), to predict current network congestion. LRD is discussed in greater detail below. The predicted network congestion information is then used to adjust the accuracy of error discriminator 218.

Data server 102 further includes a transmission rate controller 222 that adjusts the data transmission rate of the data server based on network congestion and other factors, as discussed herein. A user interface 224 in data server 102 allows one or more users, such as network administrators, to access the data server and manage the operation of the data server.

### An Exemplary Procedure for Communicating Data

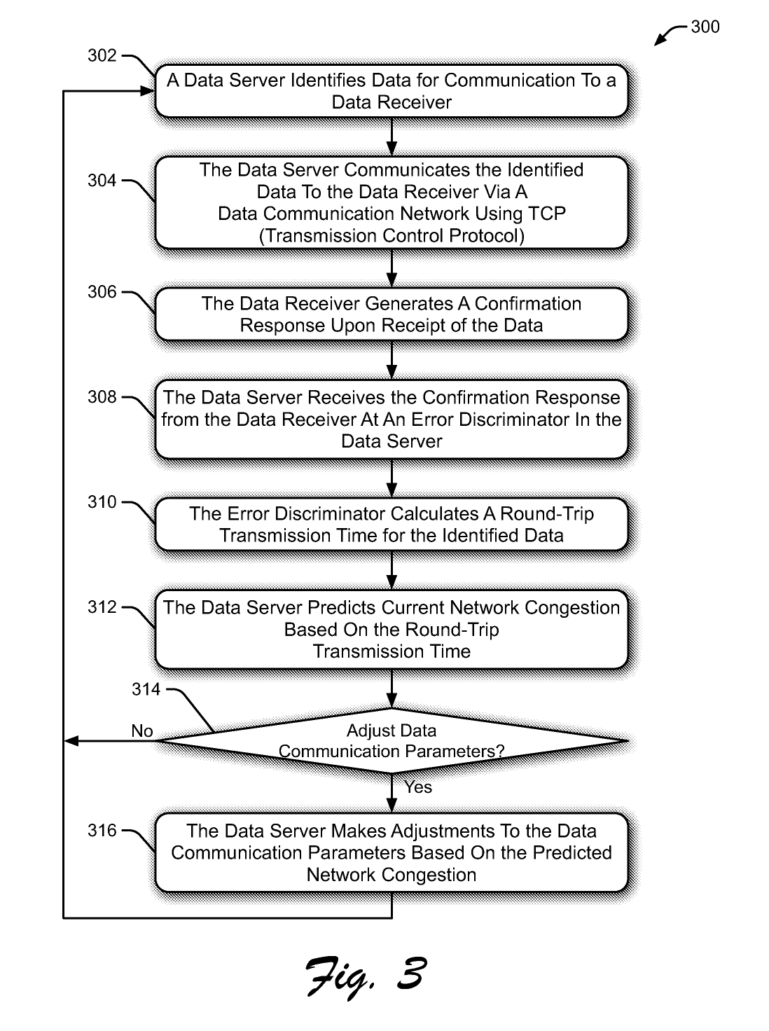

FIG. 3 shows an example procedure 300 for communicating data from a data server to a data receiver, according to one embodiment. Initially, a data server identifies data for communication to a data receiver (block 302). The identified data may be received from one or more sources, and may include any type of data. The data server then communicates the identified data to the data receiver via a data communication network using TCP (Transmission Control Protocol) at block 304. In particular embodiments, the identified data is communicated to multiple data receivers at substantially the same time.

After receiving the identified data, the data receiver generates a confirmation response (block 306), to confirm receipt of the identified data. The data server receives the confirmation response from the data receiver at an error discriminator in the data server (block 308). The error discriminator then calculates a round-trip transmission time for the identified data (block 310). The round-trip transmission time is the elapsed time between the initial transmission of the identified data from the data server and the receipt of the confirmation response by the error discriminator.

The data server then predicts current network congestion in the data communication network based on the round-trip transmission time (block 312). Based on the predicted network congestion in the data communication network, the data server determines whether an adjustment is necessary in any of the data communication parameters (block 314). The data communication parameters include, for example, data transmission rate, retransmission timeout back off, error discriminator accuracy and the size of the congestion window. The congestion window used in TCP determines the amount of data that can be in the process of being transmitted from the data server to the data receiver. By limiting the amount of data being transmitted, the congestion window helps prevent the transmission of too much data across an already congested network or communication link. The congestion window is also referred to as a “transmission window.” Additional details regarding the adjustment of the data communication parameters are discussed below.

If no adjustments are necessary, the procedure returns to block 302 to identify additional data for communication to the data receiver. If one or more data communication parameters need adjustment, the data server adjusts the data communication parameters based on the predicted network congestion (block 316), and returns to block 302 to continue processing data.

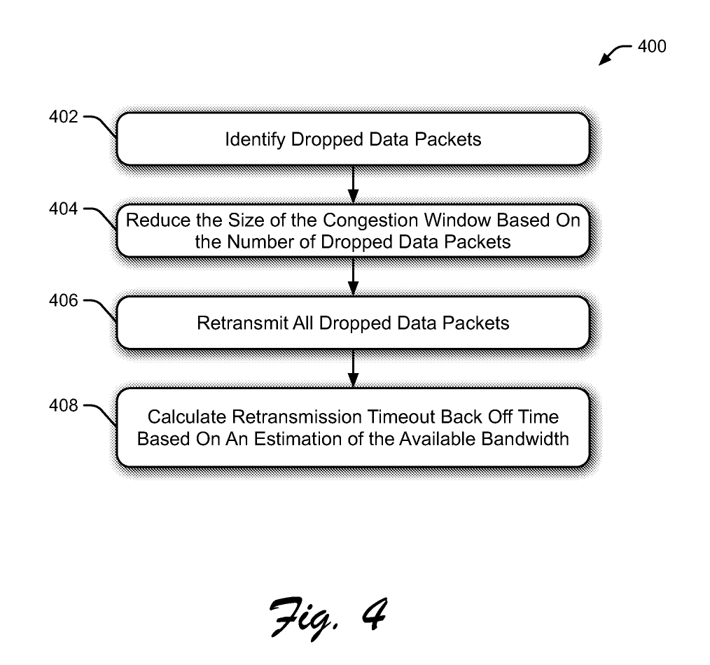

FIG. 4 shows an example procedure 400 for responding to dropped data packets, according to one embodiment. Initially, the data server identifies dropped data packets (block 402). The size of the congestion window is then reduced based on the number of dropped data packets (block 404). The data server then retransmits all dropped packets (block 406). Finally, the data server calculates a retransmission timeout back off time based on an estimation of the available bandwidth (block 408).

When multiple dropped data packets occur in the same congestion window, TCP generally reduces its sending rate significantly and waits for the retransmission timeout to recover the lost packets. However, the data communication systems and methods discussed herein retransmit multiple dropped data packets from the same congestion window.

As mentioned above, the error discriminator (e.g., error discriminator 218) calculates a round-trip transmission time for data between the data server and a data receiver. Additionally, the error discriminator accuracy is at least partially controlled by LRD traffic correlation information. In a particular implementation, three different algorithms are used to manage the data communication activities of the data server. Those algorithms are generally referred to as a congestion window algorithm, a multiple drops algorithm and a retransmission timeout algorithm. These algorithms are used, for example, by the error discriminator when transmission errors occur. The congestion window algorithm calculates the number of packets dropped in a single congestion window by subtracting the number of duplicate acknowledgements from the window size. The algorithm then reduces the congestion window size by the number of dropped packets. The multiple drops algorithm resends a number of packets equal to the number of dropped packets. The retransmission timeout algorithm estimates the available bandwidth and uses that estimate to determine the retransmission timeout back off time instead of using exponential back off as defined in TCP. These three algorithms are discussed in greater detail below.

The congestion window algorithm reduces the congestion window size by the number of dropped packets in the last congestion window. The congestion window size is reduced for both congestion errors and transmission (e.g., non-congestion) errors. This approach helps prevent increasing congestion when the error discriminator incorrectly identifies a congestion drop as a transmission drop. The decision to reduce the congestion window size is delayed until all duplicate acknowledgements for the current window are received. The duplicate acknowledgement typically indicates a dropped packet, but may also indicate that one packet has left the network (e.g., has been received by the data receiver). The number of packets that were dropped for a particular congestion window are estimated using the following equation:

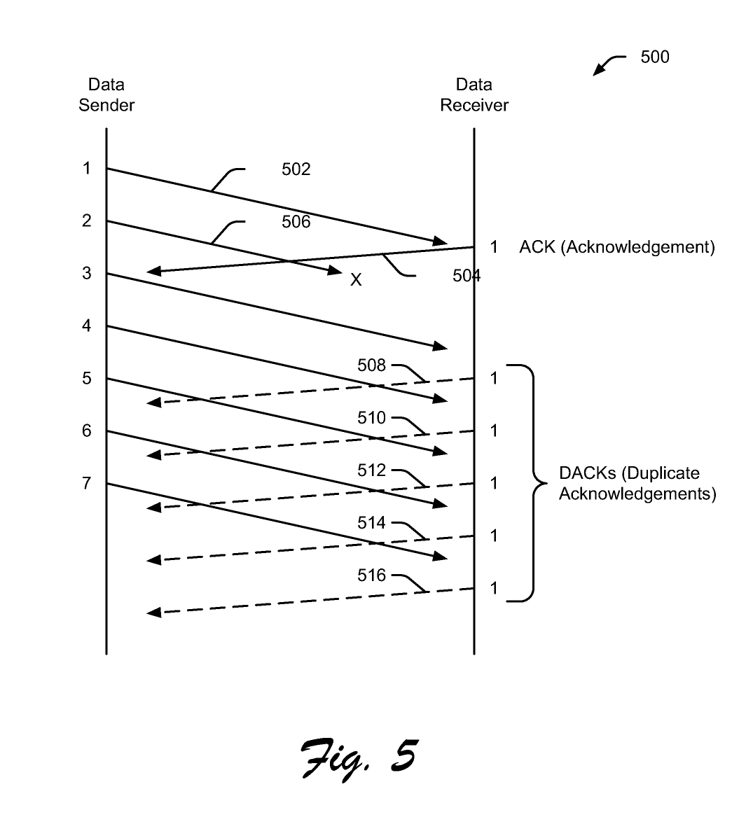

DroppedPackets=WindowSize−(#ACKs+#DACKs)

Where #ACKs is the number of acknowledgements received and #DACKs is the number of duplicate acknowledgements received. The calculated number of dropped packets (DroppedPackets) is used to reduce the size of the current window. Existing TCP systems reduce the size of the current window after receiving three duplicate acknowledgements. However, the data communication systems and methods discussed herein delay the decision to reduce the size of the current window until all duplicate acknowledgements are received for the current window, as shown in FIG. 5. The equation above for DroppedPackets subtracts the number of ACKs and DACKs from the window size to determine the number of data packets that did not reach the data receiver (e.g., dropped data packets).

FIG. 5 shows an example data transmission 500 having multiple DACK signals, according to one embodiment. A first data packet 502 is transmitted from a data sender to a data receiver. A corresponding acknowledgement (ACK) signal 504 is then sent from the data receiver to the data sender, indicating receipt of first data packet 502 by the data receiver. The data sender then sends a second data packet 506, which is dropped. This dropped data packet causes the remaining data packets sent by the data sender to be received out of order by the data receiver. In the example of FIG. 5, the data receiver sends multiple DACK signals 508, 510, 512, 514 and 516 as a result of the dropped data packet 506. The data sender sends seven data packets (numbered 1-7), which corresponds to the window size. The data receiver receives the first data packet 502 and sends an ACK 504 for that first data packet. Since the second data packet 506 is dropped, data packets 3-7 are received in the wrong order, causing the data receiver to send the five DACK signals 508-516. Using the above formula, DroppedPackets=7−(1+5)=1 (i.e., one dropped packet). The DroppedPackets formula is applied after the data sender receives the last DACK 516.

In the example of FIG. 5, instead of reducing the size of the window by 50% as performed by existing TCP devices, the data communication systems and methods described herein reduce the size of the window by one (based on one dropped packet). Thus, the size of the window is reduced from seven data packets to six data packets. This approach makes a smaller adjustment to the window for small error rates. FIG. 5 shows a particular example of the communication of data packets as well as ACK and DACK signals. In another embodiment, all data packets associated with a window are received by the data receiver before the data sender receives any ACK or DACK signals.

The multiple drops algorithm resends a number of packets equal to the number of dropped packets. In many networks, such as wireless networks, packet drops often occur in bursts. The multiple drops algorithm uses the set of duplicate acknowledgements received after the first dropped packet to estimate the number of dropped packets in a particular congestion window. The algorithm then resends that number of packets starting with the first dropped packet.

The retransmission timeout algorithm estimates the available bandwidth and uses that bandwidth estimate to determine the retransmission timeout back off time. The new retransmission timeout back off time is calculated using the following equation:

RTO=RTO*2^{f(n)}

where RTO is the retransmission timeout and f(n) represents is a function of the number of failed retransmissions (n) which is calculated based on the available bandwidth. The formula to calculate f(n) is discussed below. The available bandwidth is determined by calculating the rate of received acknowledgements, where each acknowledgement represents one segment size that has been delivered successfully. For example, the available bandwidth (bw) can be calculated as follows:

bw=segment_size/Tᵢ−T₍ᵢ₋₁₎

where Tᵢ is the time of receiving ACKᵢ and T₍ᵢ₋₁₎ is the time of receiving ACK₍ᵢ₋₁₎. This calculation of bw can be performed after receiving at least two acknowledgements. Next, a weighted average of the available bandwidths is calculated to filter out sudden changes. This weighted average is calculated as follows:

avail_bw=β*avail_bw+(1−β)*bw

where β has a value in the range of 0.8 to 0.9. This weighted average filters out sudden fluctuations in the bandwidth and, instead, considers longer-term average bandwidth. The range in values for β are selected as being similar to TCP recommendations associated with calculating average round trip time. After calculating the first bw value, that value is set equal to avail_bw. Finally, the value of f(n) is calculated using the following equation:

f(n)=n*(1−avail_bw/max_avail_bw)

where max_avail_bw is the maximum value of the available bandwidth measured over the time period being analyzed, and n represents the number of failed retransmission attempts. As discussed above, the value of f(n) is used in calculating a new back off policy using: RTO=RTO*2^{f(n)}.

Using the equations discussed above, if the error discriminator determines that a particular error is a transmission error, the retransmission timeout value is calculated based on the available bandwidth, which typically provides faster data transmission than the traditional TCP approach.

The error discriminator discussed herein (e.g., error discriminator 218 in FIG. 2) can discriminate between errors that occur during congestion phases and errors that occur during non-congestion phases (also referred to as “transmission errors”). The error discriminator is referred to as an “end-to-end error discriminator” and uses the round-trip transmission time to determine whether the errors are congestion-based errors or transmission errors. For example, an increase in the round-trip transmission time often indicates an increase in network congestion.

In a particular implementation, the error discriminator operates in one of two states: a congestion state or a non-congestion state. When the error discriminator is in a congestion state, dropped packets are considered to be congestion drops. When the error discriminator is in a non-congestion state, dropped packets are considered to be transmission drops. The error discriminator enters the congestion state when the round-trip transmission time exceeds a threshold value, such as 0.3. The error discriminator enters the non-congestion state when the round-trip transmission time falls below a second threshold value, such as 0.5.

The congestion predictor (e.g., congestion predictor 220 in FIG. 2) uses packet delay information to predict network congestion. In one embodiment, the congestion predictor determines packet delay based on link propagation delay and queuing delay. The link propagation delay varies depending on the type of communication link. The queuing delay is the time during which the packet is on one or more intermediate nodes. The queuing delay includes the queue waiting time and the service time. Increases in the network load generally cause an increase in the queuing delay.

The data communication systems and methods described herein refer to a variable “congestion edge”, which is a threshold value used to determine whether a packet drop is caused by network congestion. The congestion edge is a boundary between the congested state and the non-congested state. The congestion edge (using variable name “Cedge”) is determined as follows:

Cedge=minRTT+midalpha*(maxRTT−minRTT)

where Cedge is a value between maxRTT (maximum round-trip transmission time) and minRTT (minimum round-trip transmission time). The value of “midalpha” determines how close Cedge is to the minRTT or maxRTT. When the value of midalpha increases, Cedge moves toward the maxRTT. As the value of midalpha decreases, Cedge moves toward minRTT. In a particular embodiment, the value of midalpha is selected in the range of 0.05 to 0.75. An increase in the value of Cedge causes the error discriminator to classify more errors as transmission errors. Similarly, a decrease in Cedge causes the error discriminator to classify more errors as congestion errors. Thus, the state of the error discriminator is determined by the value of Cedge.

When a packet drop occurs, the round-trip transmission time is compared to the value of Cedge. In a particular embodiment, instead of using the current round-trip transmission time, the error discriminator applies a weighted average of the round-trip transmission time (referred to as “AvgRTT”). AvgRTT is calculated as in standard TCP using an exponential weighted average having weight=α. The use of an exponential weighted average filters out sudden changes in the round-trip transmission time, which might cause disruptive oscillations between the congestion and non-congestion states. The value of AvgRTT is calculated as follows:

AvgRTT=α*AvgRTT−(1−α)*RTT

where RTT is the current round-trip transmission time. In particular embodiments, the value of α is set in the range of 0.8 to 0.9.

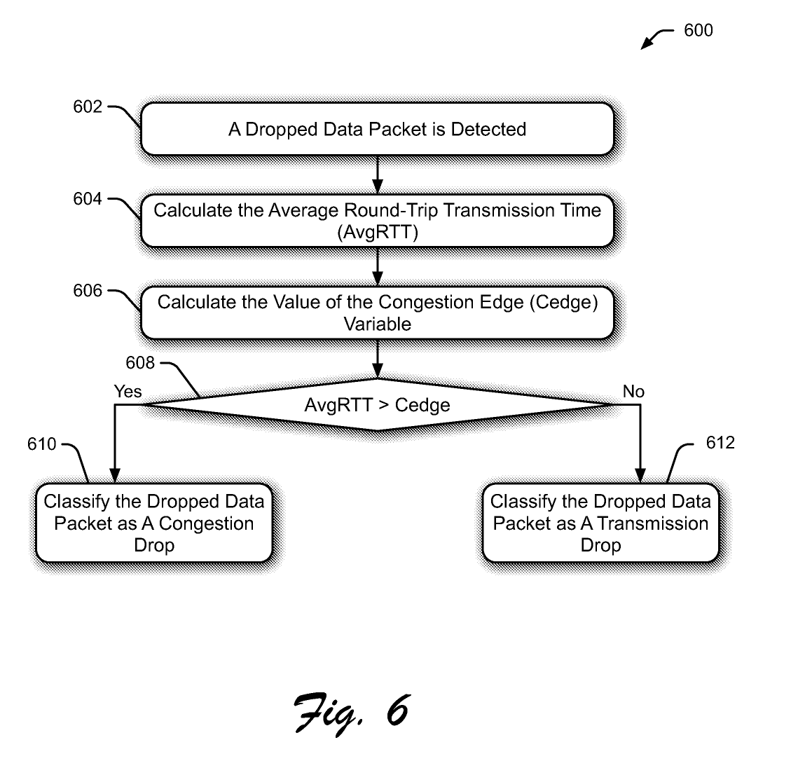

FIG. 6 shows an example procedure 600 for classifying a dropped packet as a congestion-related drop or a transmission drop, according to one embodiment. Procedure 600 is performed, for example, by error discriminator 218 and/or other components in data server 102. Initially, a dropped data packet is detected (block 602). The procedure then calculates the average round-trip transmission time (AvgRTT) using the equation discussed above (block 604). Next the congestion edge (Cedge) variable is calculated using the equation described above (block 606). Procedure 600 then determines whether the average round-trip transmission time is greater than the congestion edge value (block 608). If the average round-trip transmission time is greater than the congestion edge value, the dropped data packet is classified as a congestion drop (block 610). In this situation, the standard TCP procedures are followed, such as reducing the size of the congestion window by 50%.

If the average round-trip transmission time is not greater than the congestion edge value (i.e., the average round-trip transmission time is less than or equal to the congestion edge value), the dropped packet is classified as a transmission drop (block 612). In this situation, the alternate procedures discussed herein are applied to handle the dropped data packet. For example, the procedures discussed with respect to FIG. 4 and the three algorithms (congestion window algorithm, multiple drops algorithm and retransmission timeout algorithm) discussed above are applied to manage the dropped data packet.

In a particular embodiment, when a data packet is dropped and AvgRTT is below Cedge, the dropped data packet is initially classified as a transmission drop. The data server then calculates another congestion window threshold (tthresh). The value of tthresh is first determined based on the size of the data sender's window when the first congestion drop occurs. Since a timeout event often indicates severe network congestion, the value of tthresh is recalculated after each timeout event. The value of tthresh is recalculated because a timeout event indicates that the current tthresh value is not appropriate to prevent the creation of congestion. In operation, if the congestion window is larger than the tthresh value, then the dropped packet is considered to be a congestion error and is handled using the standard TCP procedures. Otherwise, the dropped packet is considered a transmission error and is handled using the procedures discussed with respect to FIG. 4 and the three algorithms discussed above.

As discussed above, the congestion predictor (e.g., congestion predictor 220 in FIG. 2) uses packet delay information to predict network congestion. For Internet-based data traffic, it has been found that the traffic generated by TCP/IP sources has a memory and a bursty nature, which shows correlation over large time periods. This property of Internet traffic is commonly referred to as Long Range Dependence (LRD). This LRD correlation may affect round-trip transmission times of data packets, which allows for the prediction of network congestion using the correlation in a window of round-trip transmission time readings.

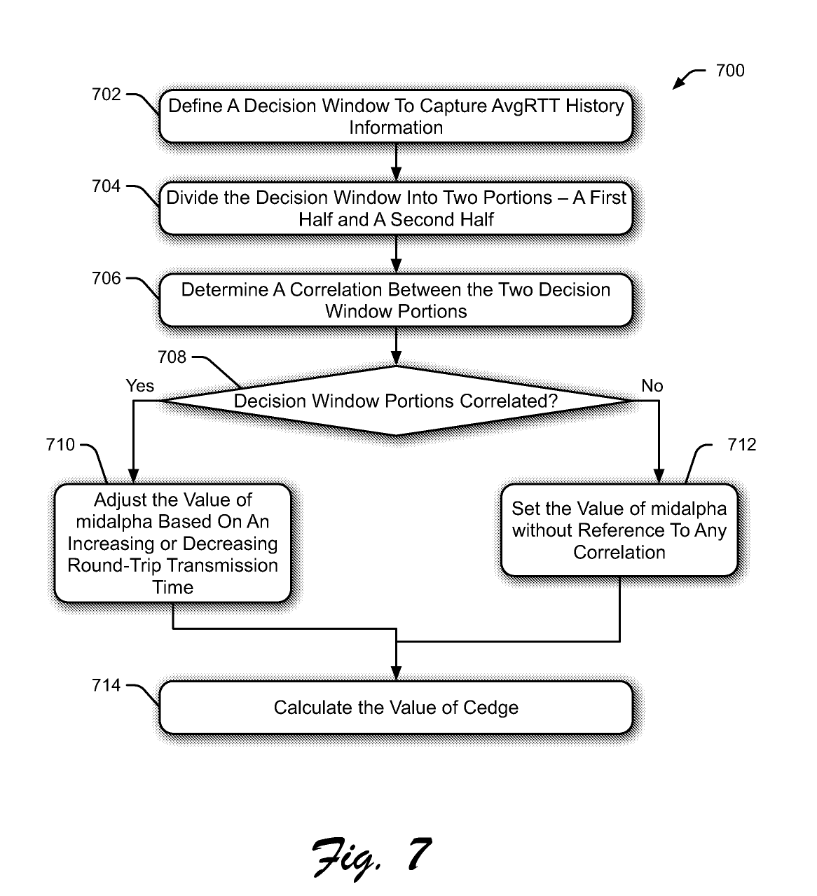

FIG. 7 shows an example procedure 700 for calculating a congestion edge, according to one embodiment. In one embodiment, procedure 700 dynamically calculates the congestion edge based on correlation of average round-trip transmission time values. Initially, the procedure defines a decision window to capture AvgRTT history information (block 702). The decision window is a sliding window that holds the last n AvgRTT values. The decision window is divided into two portions (block 704). One of the two portions contains the first half of the AvgRTT values, the other portion contains the second half of the AvgRTT values. The procedure then determines whether there is a correlation between the two decision window portions (block 706). To determine whether a correlation exists, the decision window is divided into sets X and Y, each set having a size m. The correlation between sets X and Y are calculated as follows:

$$Correlation ( X , Y ) = \frac{{\sum }_{i = 1}^{m} ( ( Xi - \overline{X} ) ( Yi - \overline{Y} ) )}{σ x * σ y}$$

where σx is the standard deviation and calculated as follows:

$$σ x = \sqrt{\frac{1}{m} {\sum }_{i = 1}^{m} {( Xi - \overline{X} )}^{2}}$$

The value of σy is calculated in a similar manner as σx. The resulting correlation is a number between −1 and 1.

A positive correlation value (e.g., a value between 0 and 1) indicates that both decision window portions are increasing (e.g., the AvgRTT values are increasing), or both decision window portions are decreasing (e.g., the AvgRTT values are decreasing). A negative correlation indicates that one decision window portion is increasing while the other decision window portion is decreasing.

As discussed above, the value of Cedge is calculated as follows:

Cedge=minRTT+midalpha*(maxRTT−minRTT)

In the example of FIG. 7, if the decision window portions are not correlated (block 708), the procedure sets the value of “midalpha” in the Cedge calculation without reference to any correlation (block 712). As discussed above, the value of midalpha determines how close Cedge is to the minRTT or maxRTT.

If the decision window portions are correlated (block 708), the procedure adjusts the value of midalpha based on an increasing or decreasing round-trip transmission time (block 710). If both decision window portions are increasing, they are expected to continue increasing in the future, which will lead to increased congestion. In this situation, it is desirable to have a lower Cedge value by using a lower midalpha value. A lower Cedge value is desirable to cause the error discriminator to be more conservative (e.g., considering more dropped packets as congestion drops, which reduces the data transmission rate). In this example, midalpha is calculated as follows:

midalpha=1−correlation

where “correlation” is the correlation factor associated with the two decision window portions. Using the above equation, the value of midalpha decreases as the correlation strengthens (a stronger correlation indicates a greater likelihood that the increasing pattern will continue).

If both decision window portions are decreasing, they are expected to continue decreasing in the future, which will lead to decreased congestion. In this situation, it is desirable to have a higher Cedge value. This is accomplished by setting the value of midalpha equal to the correlation value.

After determining the value of midalpha using one of the above techniques, procedure 700 calculates the value of Cedge using the above equation (block 714). In particular embodiments, the procedure of FIG. 7 dynamically calculates (and recalculates) the Cedge value based on changes in the correlation between the two decision window portions. For example, procedure 700 can be repeated at regular intervals (or on a continuous basis) to update the calculated value of Cedge.

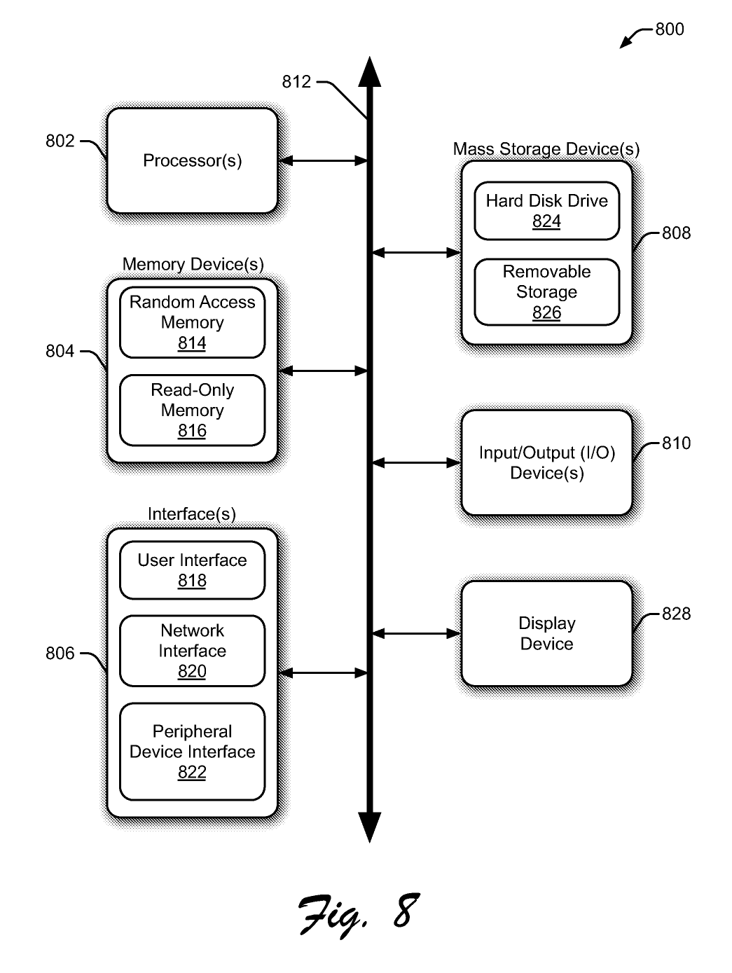

FIG. 8 is a block diagram illustrating an example computing device 800. Computing device 800 may be used to perform various procedures, such as those discussed herein. Computing device 800 can function as a server, a client, a worker node, or any other computing entity. For example, computing device 800 can function as a data server or a data receiver as discussed herein. Computing device 800 can be any of a wide variety of computing devices, such as a desktop computer, a notebook computer, a server computer, a handheld computer, and the like.

Computing device 800 includes one or more processor(s) 802, one or more memory device(s) 804, one or more interface(s) 806, one or more mass storage device(s) 808, one or more Input/Output (I/O) device(s) 810, and a display device 828 all of which are coupled to a bus 812. Processor(s) 802 include one or more processors or controllers that execute instructions stored in memory device(s) 804 and/or mass storage device(s) 808. Processor(s) 802 may also include various types of computer-readable media, such as cache memory.

Memory device(s) 804 include various computer-readable media, such as volatile memory (e.g., random access memory (RAM)) 814 and/or nonvolatile memory (e.g., read-only memory (ROM)) 816. Memory device(s) 804 may also include rewritable ROM, such as Flash memory.

Mass storage device(s) 808 include various computer readable media, such as magnetic tapes, magnetic disks, optical disks, solid state memory (e.g., Flash memory), and so forth. As shown in FIG. 8, a particular mass storage device is a hard disk drive 824. Various drives may also be included in mass storage device(s) 808 to enable reading from and/or writing to the various computer readable media. Mass storage device(s) 808 include removable media 826 and/or non-removable media.

I/O device(s) 810 include various devices that allow data and/or other information to be input to or retrieved from computing device 800. Example I/O device(s) 810 include cursor control devices, keyboards, keypads, microphones, monitors or other display devices, speakers, printers, network interface cards, modems, lenses, CCDs or other image capture devices, and the like.

Display device 828 includes any type of device capable of displaying information to one or more users of computing device 800. Examples of display device 828 include a monitor, display terminal, video projection device, and the like.

Interface(s) 806 include various interfaces that allow computing device 800 to interact with other systems, devices, or computing environments. Example interface(s) 806 include any number of different network interfaces 820, such as interfaces to local area networks (LANs), wide area networks (WANs), wireless networks, and the Internet. Other interfaces include user interface 818 and peripheral device interface 822.

Bus 812 allows processor(s) 802, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 800, and are executed by processor(s) 802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### CONCLUSION

Although the systems and methods for communicating data have been described in language specific to structural features and/or methodological operations or actions, it is understood that the implementations defined in the appended claims are not necessarily limited to the specific features or actions described. Rather, the specific features and operations for communicating data are disclosed as exemplary forms of implementing the claimed subject matter.

1. A computer-implemented method comprising:
communicating data to a data receiver via a data communication network;
receiving a confirmation response from the data receiver indicating receipt of the data, wherein the confirmation response is received by an error discriminator;
calculating a round-trip transmission time for the data;
predicting network congestion associated with the data communication network based on the round-trip transmission time; and
adjusting a data communication rate if the predicted network congestion exceeds a threshold value.

2. A computer-implemented method as recited in claim 1 wherein data is communicated to the data receiver using TCP (Transmission Control Protocol).

3. A computer-implemented method as recited in claim 1 wherein adjusting a data communication rate includes adjusting a congestion window size.

4. A computer-implemented method as recited in claim 1 wherein adjusting a data communication rate includes adjusting a retransmission timeout back off time.

5. A computer-implemented method as recited in claim 1 wherein predicting network congestion includes comparing the round-trip transmission time with historical round-trip transmission times.

6. A computer-implemented method as recited in claim 1 wherein predicting network congestion includes determining correlation between recent average round-trip transmission times and historical average round-trip transmission times.

7. A computer-implemented method as recited in claim 1 wherein predicting network congestion includes calculating a congestion edge based on minimum round-trip transmission times and maximum round-trip transmission times.

8. A computer-implemented method as recited in claim 1 wherein the round-trip transmission time for the data is the elapsed time between the initial communication of data and the receipt of the confirmation response by the error discriminator.

9. A computer-implemented method as recited in claim 1 further comprising adjusting the error discriminator accuracy based on the predicted network congestion.

10. A computer-implemented method as recited in claim 1 further comprising:
determining a number of dropped packets in a congestion window; and
reducing the congestion window size by the number of dropped packets.

11. A computer-implemented method as recited in claim 10 further comprising retransmitting all dropped packets in the congestion window.

12. A computer-implemented method as recited in claim 10 further comprising:
estimating an available bandwidth across the data communication network; and
calculating a retransmission timeout back off time based on the estimated available bandwidth.

13. A computer-implemented method comprising:
communicating a plurality of data packets to a data receiver via a data communication network using TCP (Transmission Control Protocol);
identifying a plurality of dropped data packets;
reducing a congestion window size by the number of dropped data packets; and
retransmitting all dropped data packets to the data receiver via the data communication network.

14. A computer-implemented method as recited in claim 0 further comprising:
estimating an available bandwidth across the data communication network; and
calculating a retransmission timeout back off time based on the estimated available bandwidth.

15. A computer-implemented method as recited in claim 0 further comprising:
calculating a round-trip transmission time for the data packets; and
predicting network congestion associated with the data communication network based on the round-trip transmission time.

16. A computer-implemented method as recited in claim 15 further comprising adjusting an error discriminator accuracy based on the predicted network congestion.

17. A computer-implemented method as recited in claim 0 further comprising predicting network congestion by comparing a round-trip transmission time for the data packets with historical round-trip transmission times.

18. A data server comprising:
a memory;
a processor coupled to the memory; and
an error discriminator coupled to the processor and configured to:
receive a confirmation response from a data receiver indicating receipt of a data packet communicated by the data server across a data communication network;
calculate a round-trip transmission time for the data packet; and
predict network congestion associated with the data communication network based on the round-trip transmission time.

19. A data server as recited in claim 18 wherein the error discriminator is further configured to adjust a congestion window size based on the predicted network congestion.

20. A data server as recited in claim 18 wherein the error discriminator is further configured to adjust an error discrimination accuracy based on the predicted network congestion.
